(19) United States
(12) Patent Application Publication
(10) Pub. No.: US 2008/0302219 A1
(43) Pub. Date: Dec. 11, 2008

(54) STRUCTURE OF A WRENCH

(76) Inventor: CHIN-SHUN CHENG, Taichung 404 (TW)

Correspondence Address: CHIN-SHUN CHENG, No.37-2. Ching-Dau 1st Street, Taichung, 404, TW

(21) Appl. No.: 11/761,367

(22) Filed: Jun. 11, 2007

(51) Int. Cl. B25B 23/159

(52) U.S. Cl. 81/477

(57) ABSTRACT

The present invention relates to a structure of wrench, which is mainly that a handle extends out from one side of a driving head integrally, a plurality of forefront surfaces and grooves are disposed around the internal periphery of the opening of the driving head in an interlaced order, and the forefront surfaces each has a concavity disposed on the middle portion of the protruded curved surface thereof. The concavities have different shapes from grooves and both are to be used to accommodate a workpiece. Besides, projected stop parts are provided on inside of the opening, with which the objectives of being suitable for various workpieces in multiple specifications and preventing the workpieces from passing through the driving head randomly would be achieved.

### FIELD OF THE INVENTION

This invention relates to a structure of wrench, and more particularly to a wrench that is suitable of being used for various workpieces in multiple specifications, and able to prevent the workpieces from passing through thereof randomly.

### BACKGROUND OF THE INVENTION

A conventional structure of wrench, such as U.S. Pat. No. 5,983,758, as shown in FIG. 61, has a handle 71 extending out integrally from one side of an annular driving head 70 that is internally equipped with twelve equidistant and continuous V-shaped grooves 72 with the same shape, six of the twelve equidistant V-shaped grooves 72 have each a stop part 73 on one end such that the six grooves 72 are not through. When the driving head 70 is engaged with a workpiece, top of a workpiece would be limited by the stop part 73 and then efficacy of preventing the workpiece taking off randomly from the wrench would be achieved. However, the conventional wrench aforementioned has the shortcoming as follows.

General workpieces have various shapes, such as gear-shaped, E-shaped, triangle, quadrangle, hexagon, etc. The conventional driving head 70 aforementioned has twelve V-shaped grooves 72, which can only fit a hexagonal or dodecagonal workpiece. Therefore, the conventional driving head 70 is suitable for limited various workpieces so as to cause a shortcoming of inconvenience in use.

### SUMMARY OF THE INVENTION

The main objective of the present invention is to provide a wrench that is suitable of being used for various workpieces, and for preventing the workpieces from passing through the driving head of the wrench randomly. The structure of the wrench is that a plurality of forefront surfaces and grooves are disposed around the internal periphery of the opening of the driving head in an interlaced order, and the forefront surfaces each has a concavity disposed on the middle portion of the protruded curved surface thereof. The concavities have different shapes from grooves and both are to be used to accommodate a workpiece together. Besides, projected stop parts are provided on inside of the opening, with which the objectives of being suitable for various workpieces in multiple specifications and preventing workpieces from passing through the wrench randomly would be achieved.

The present invention will become more obvious from the following description when taken in connection with the accompanying drawings that show, for purposes of illustration only, a preferred embodiment in accordance with the present invention.

### BRIEF DESCRIPTION OF THE DRAWINGS

FIG. 1 is a perspective view of the wrench of the present invention;

FIG. 2 is a top view of the wrench of the present invention;

FIG. 3 is a partial enlarged view of the wrench of the present invention;

FIG. 4 is a perspective view of rotating a hexagonal workpiece of the present invention;

FIG. 5 is a top view of rotating a hexagonal workpiece of the present invention;

FIG. 6 is a partial enlarged view of rotating a hexagonal workpiece of the present invention;

FIG. 7 is a perspective view of rotating a hexagonal workpiece of the present invention;

FIG. 8 is a top view of rotating a hexagonal workpiece of the present invention;

FIG. 9 is a partial enlarged view of rotating a hexagonal workpiece of the present invention;

FIG. 10 is a perspective view of rotating an E-shaped workpiece of the present invention;

FIG. 11 is a top view of rotating an E-shaped workpiece of the present invention;

FIG. 12 is a perspective view of rotating a gear-shaped workpiece of the present invention;

FIG. 13 is a top view of rotating a gear-shaped workpiece of the present invention;

FIG. 14 is a perspective view of rotating a triangular workpiece of the present invention;

FIG. 15 is a top view of rotating a triangular workpiece of the present invention;

FIG. 16 is a perspective view of the second embodiment of the present invention;

FIG. 17 is a top view of the second embodiment of the present invention;

FIG. 18 is a perspective view of the third embodiment of the present invention;

FIG. 19 is a top view of the third embodiment of the present invention;

FIG. 20 is a perspective view of the fourth embodiment of the present invention;

FIG. 21 is a top view of the fourth embodiment of the present invention;

FIG. 22 is a perspective view of the fifth embodiment of the present invention;

FIG. 23 is a top view of the fifth embodiment of the present invention;

FIG. 24 is a perspective view of the sixth embodiment of the present invention;

FIG. 25 is a top view of the sixth embodiment of the present invention;

FIG. 26 is a perspective view of the seventh embodiment of the present invention;

FIG. 27 is a top view of the seventh embodiment of the present invention;

FIG. 28 is a perspective view of the eighth embodiment of the present invention;

FIG. 29 is a top view of the eighth embodiment of the present invention;

FIG. 30 is a perspective view of the ninth embodiment of the present invention;

FIG. 31 is a top view of the ninth embodiment of the present invention;

FIG. 32 is a perspective view of the tenth embodiment of the present invention;

FIG. 33 is a top view of the tenth embodiment of the present invention;

FIG. 34 is a perspective view of the eleventh embodiment of the present invention;

FIG. 35 is a top view of the eleventh embodiment of the present invention;

FIG. 36 is a perspective view of the twelfth embodiment of the present invention;

FIG. 37 is a top view of the twelfth embodiment of the present invention;

FIG. 38 is a perspective view of the thirteenth embodiment of the present invention;

FIG. 39 is a top view of the thirteenth embodiment of the present invention;

FIG. 40 is a perspective view of the fourteenth embodiment of the present invention;

FIG. 41 is a top view of the fourteenth embodiment of the present invention;

FIG. 42 is a perspective view of the fifteenth embodiment of the present invention;

FIG. 43 is a top view of the fifteenth embodiment of the present invention;

FIG. 44 is a perspective view of the sixteenth embodiment of the present invention;

FIG. 45 is a top view of the sixteenth embodiment of the present invention;

FIG. 46 is a perspective view of the seventeenth embodiment of the present invention;

FIG. 47 is a top view of the seventeenth embodiment of the present invention;

FIG. 48 is a perspective view of the eighteenth embodiment of the present invention;

FIG. 49 is a top view of the eighteenth embodiment of the present invention;

FIG. 50 is a perspective view of the nineteenth embodiment of the present invention;

FIG. 51 is a top view of the nineteenth embodiment of the present invention;

FIG. 52 is a perspective view of the twentieth embodiment of the present invention;

FIG. 53 is a top view of the twentieth embodiment of the present invention;

FIG. 54 is a perspective view of the twenty-first embodiment of the present invention;

FIG. 55 is a top view of the twenty-first embodiment of the present invention;

FIG. 56 is a partial enlarged view of the twenty-first embodiment of the present invention;

FIG. 57 is a perspective view of the twenty-second embodiment of the present invention;

FIG. 58 is a top view of the twenty-second embodiment of the present invention;

FIG. 59 is a perspective view of the twenty-third embodiment of the present invention;

FIG. 60 is a top view of the twenty-third embodiment of the present invention; and

FIG. 61 is a perspective view of the prior art.

### DETAILED DESCRIPTION OF THE PREFERRED EMBODIMENT

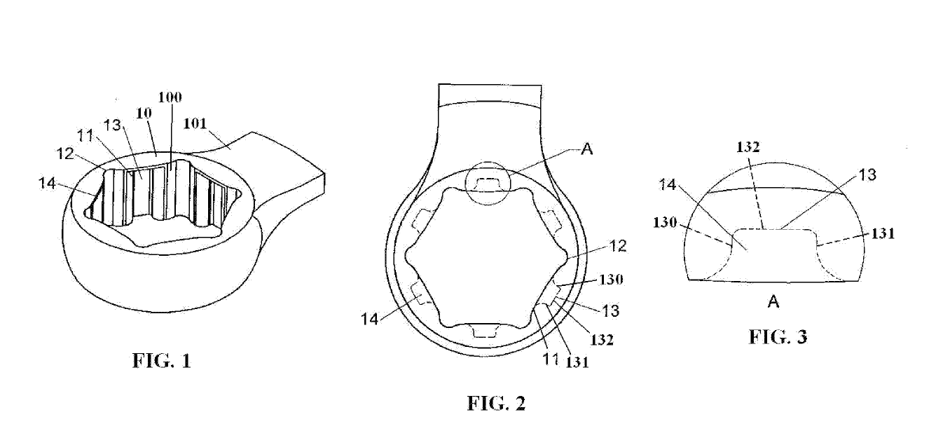

As shown in FIGS. 1 to 3, a basic structure of a box-end wrench of the present invention comprises a driving head 10 and a handle 101 extending from one side of the driving head 10 integrally. The driving head 10 is annular and has a first end and a second end in opposite directions, and a central longitudinal axis that extends to connect the first end and the second end. At least one said end of the driving head 10 is equipped with an opening 100 extending along the central longitudinal axis. The opening 100 has a plurality of grooves 12 that are distributed equidistantly around the internal periphery thereof. The extending directions of the grooves 12 are parallel to the central longitudinal axis. A portion connecting each two adjacent said grooves 12 forms a forefront surface 11. Each forefront surface 11 is equipped with a concavity 13 on the middle thereof. The extending directions of the concavities 13 are parallel to the central longitudinal axis. The concavities 13 and the grooves 12 are able to accommodate the teeth of a gear-shaped workpiece together. Wherein, one said end of the driving head 10 is equipped with at least a stop part 14 projecting toward the central longitudinal axis on the inner of the opening 100, so that when the workpiece is inserted into the opening 100 from the other said end of the driving head 10, which can be blocked by the stop part 14.

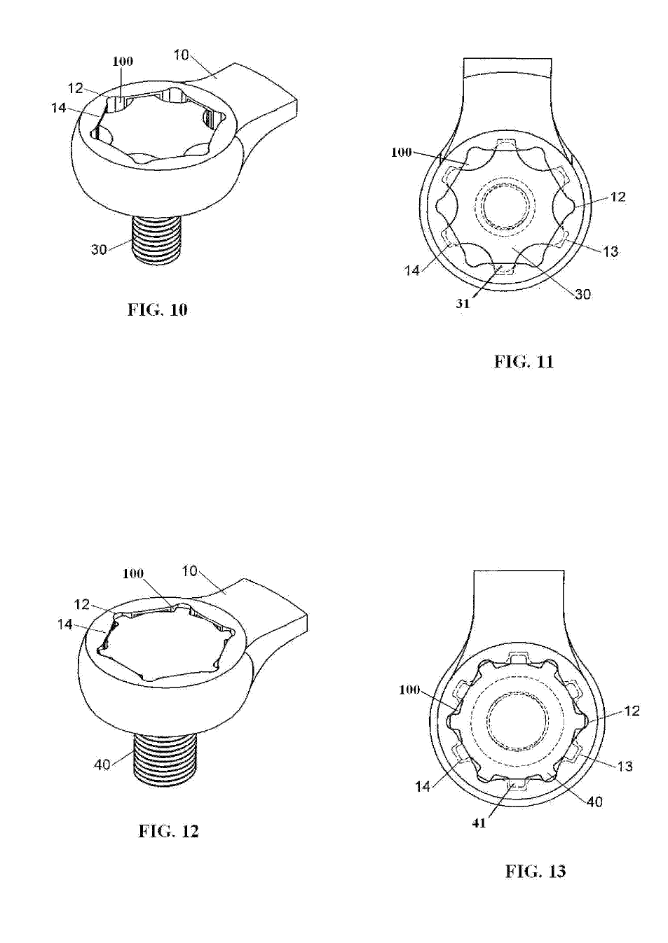

As shown in FIGS. 1 to 3, the number of the forefront surfaces 11 and the grooves 12 each are six, which are disposed annularly in an interlaced order. The forefront surfaces 11 may be a curved surface projecting toward the central longitudinal axis. The grooves 12 and the forefront surfaces 11 each are in the form of curved surfaces, and the junction of the two curved surfaces is tangent to each other. The number of the concavity 13 is six and the size of the concavity 13 is big enough to accommodate a tooth 41 of a gear-shaped workpiece 40 (as shown in FIGS. 12 and 13), or a tooth 31 of an E-shaped workpiece 30 with six encircling teeth (as shown in FIGS. 10 and 11). Moreover, in the embodiment of FIGS. 1 to 3, the concavity 13 includes two side surfaces 130, 131 and a bottom 132, in which the bottom 132 may be an arc surface or a flat surface. The included angle of the two side surfaces 130, 131 may be zero degree (namely parallel), greater or smaller than 90 degree. In the embodiment shown in FIGS. 1 to 3, the two side surfaces 130, 131 of the concavity 13 are parallel to each other, and the bottom 132 is a flat surface. Moreover, in the embodiment shown in FIGS. 1 to 3, the number of the stop part 14 is six and the stop parts 14 may be located on the concavities 13 near the first end of the driving head 10, which makes the concavities 13 not through. The distal end of the stop part 14 is in the form of a curved surface that is on the same curved surface as the forefront surface 11, with which the driving head 10 is able to fit on various shapes of workpieces and has the function of preventing the workpieces taking off randomly.

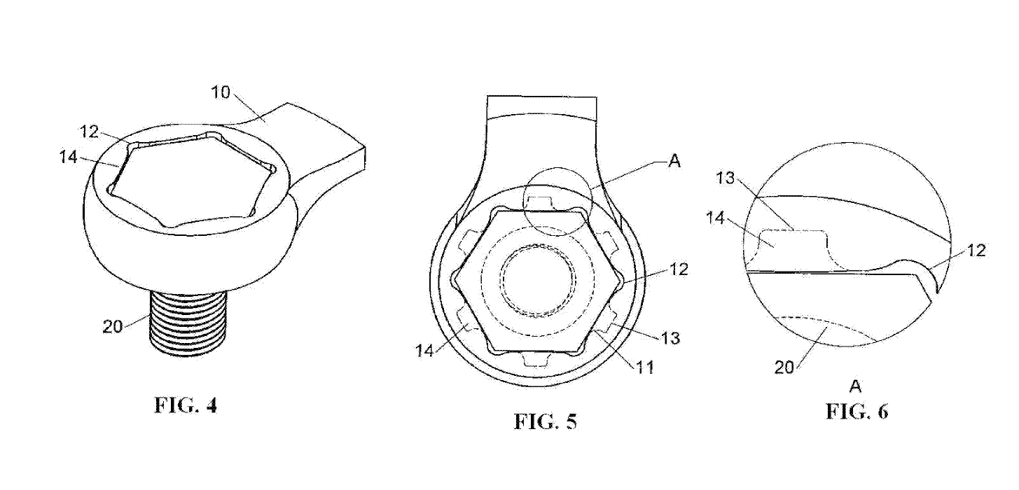

Referring to FIGS. 4 to 6, when the driving head 10 of the present invention accommodates a workpiece 20 with an angle, the forefront surfaces 11 of the driving head 10 are engaged with the six edges of the workpiece 20, which is the same as the conventional operation.

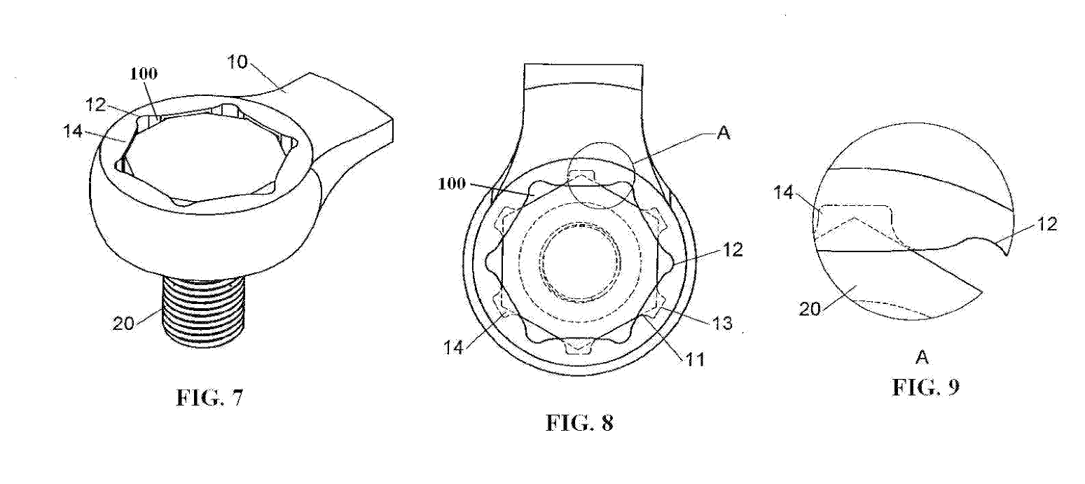

Referring to FIGS. 7 to 9, when the driving head 10 accommodates the workpiece 20 with another angle, the forefront surfaces 11 of the driving head 10 are also engaged with the six edges of the workpiece 20 and the top portions of the workpiece 20 touch the stop parts 14, so as to prevent the workpiece 20 from passing through the opening 100 of the driving head 10.

As shown in FIGS. 10 and 11, when the driving head 10 accommodates an E-shaped workpiece 30 with six teeth 31, the teeth 31 are accommodated within the concavities 13 and the top portions of the teeth 31 touch the stop parts 14, thus to prevent the E-shaped workpiece 30 from passing through the opening 100 of the driving head 10. In the embodiment of these two figures, the stop parts 14 are located on the concavities 13 near the first end of the driving head 10.

As shown in FIGS. 12 and 13, when the driving head 10 accommodates a gear-shaped workpiece 40 with twelve teeth 41, the teeth 41 are accommodated within the concavities 13 and the top portions of the teeth 41 touch the stop parts 14, thus to prevent the gear-shaped workpiece 40 from passing through the opening 100 of the driving head 10.

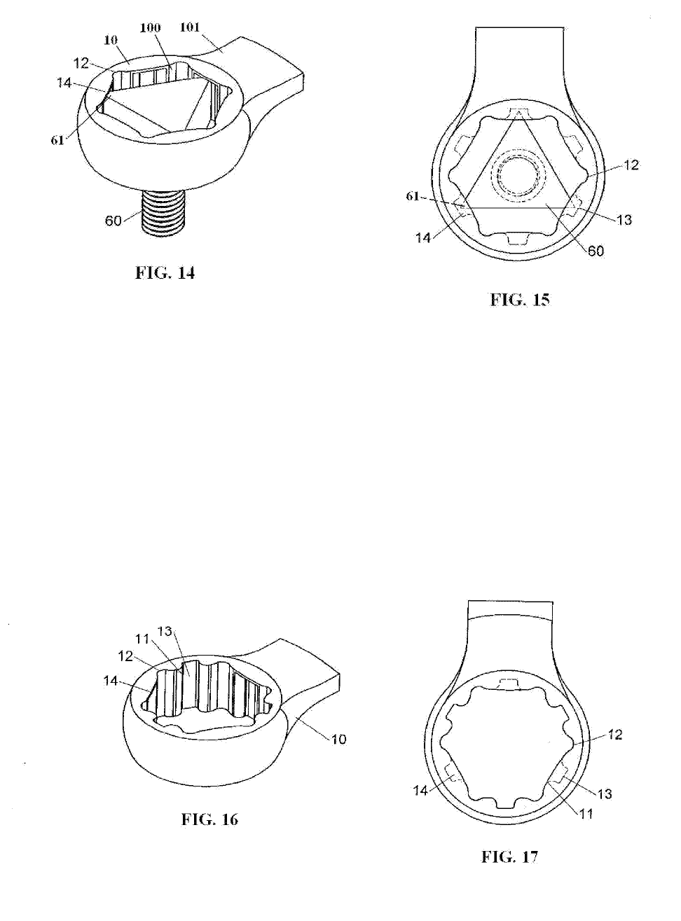

Referring to FIGS. 14 and 15, when the driving head 10 accommodates a triangular workpiece 60, corners 61 of the triangular workpiece 60 are accommodated within the concavities 13 and restricted by the stop parts 14, thus to prevent the triangular workpiece 60 from passing through the opening 100 of the driving head 10.

In the embodiment shown in FIGS. 16 and 17, the number of the stop part 14 is three, which are located on three equidistant said concavities 13 respectively.

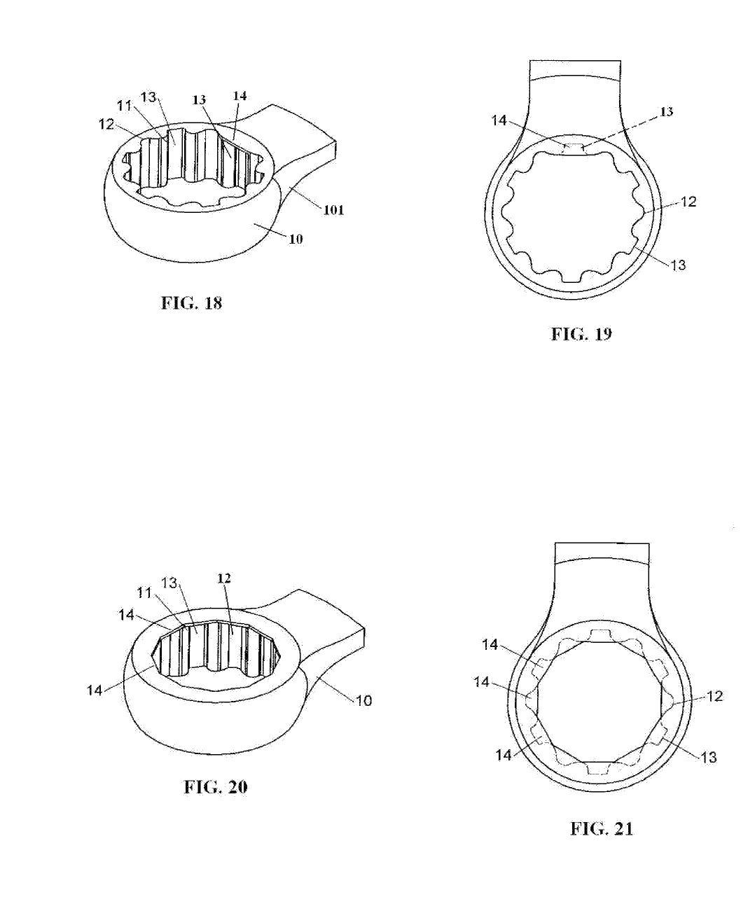

In the embodiment shown in FIGS. 18 and 19, the number of the stop part 14 is one, which is located on one said concavity 13.

In the embodiment shown in FIGS. 20 and 21, the number of the stop part 14 is twelve, which are located on the grooves 12 and the concavities 13 one by one and are all located on the first end of the driving head 10. These stop parts 14 connect with each other to form a dodecagonal inner circumference for accommodating another workpiece.

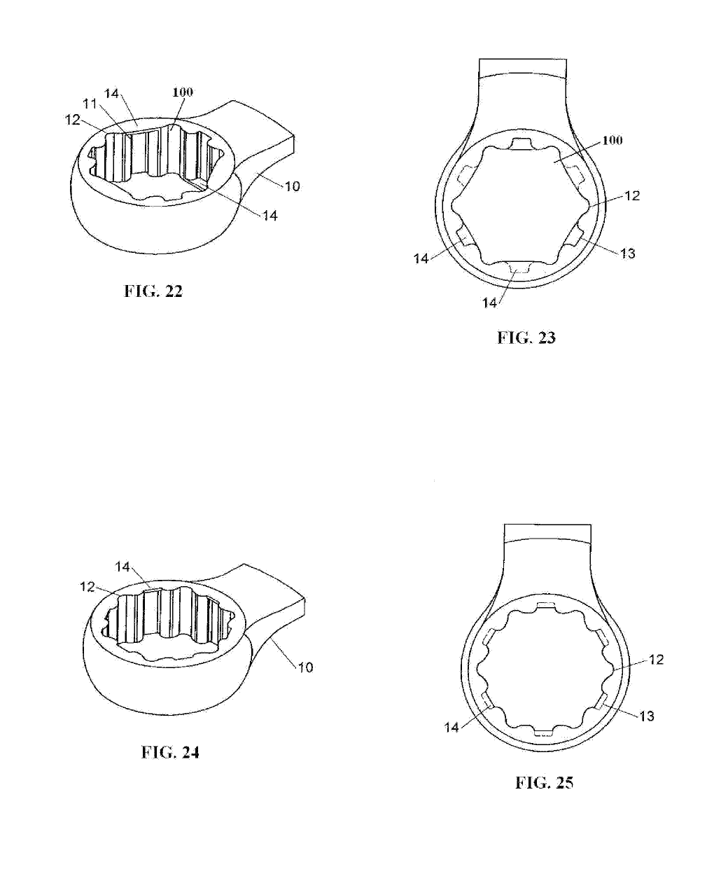

In the embodiment shown in FIGS. 22 and 23, the number of the stop part 14 is six, three of the stop parts 14 are located on the opening 100 near the first end of the driving head 10 and other three are located on the opening 100 near the second end of the driving head 10. The preferred embodiment of FIGS. 22 and 23 shows that three of the stop parts 14 are located equidistantly on the concavities 13 near the first end of the driving head 10 and other three are located equidistantly on the concavities 13 near the second end of the driving head 10.

In the embodiment shown in FIGS. 24 and 25, the ends of the stop parts 14 are formed as flat surfaces.

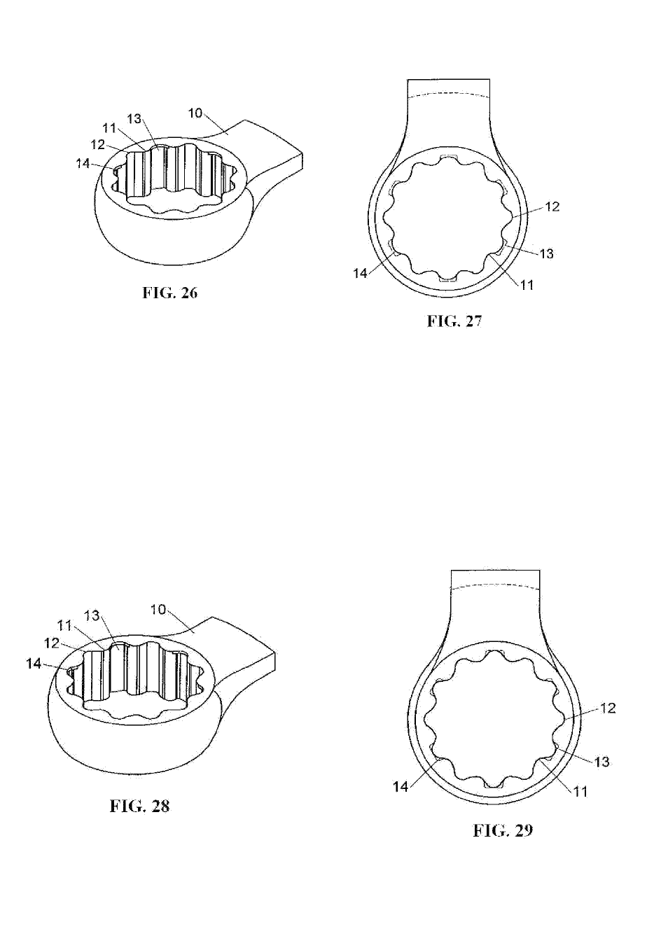

In the embodiment shown in FIGS. 26 and 27, the ends of the stop parts 14 are formed as concave curved surfaces, the forefront surfaces 11 are convex curved surface, the junctions of the curved surfaces of the stop parts 14 and the curved surfaces of the forefront surfaces 11 are round corners. Furthermore, the ends of the stop parts 14 are formed as concave curved surfaces, and the shapes of the concave curved surfaces of the stop parts 14 can be the same as the groove 12.

In the embodiment shown in FIGS. 28 and 29, the ends of the stop parts 14 are formed as concave curved surfaces and the junctions of the curved surfaces of the stop parts 14 and the forefront surfaces 11 are round corners. The curved surfaces of the stop parts 14 are paraboloid and the junctions of the paraboloid and the concavities 13 are round corners.

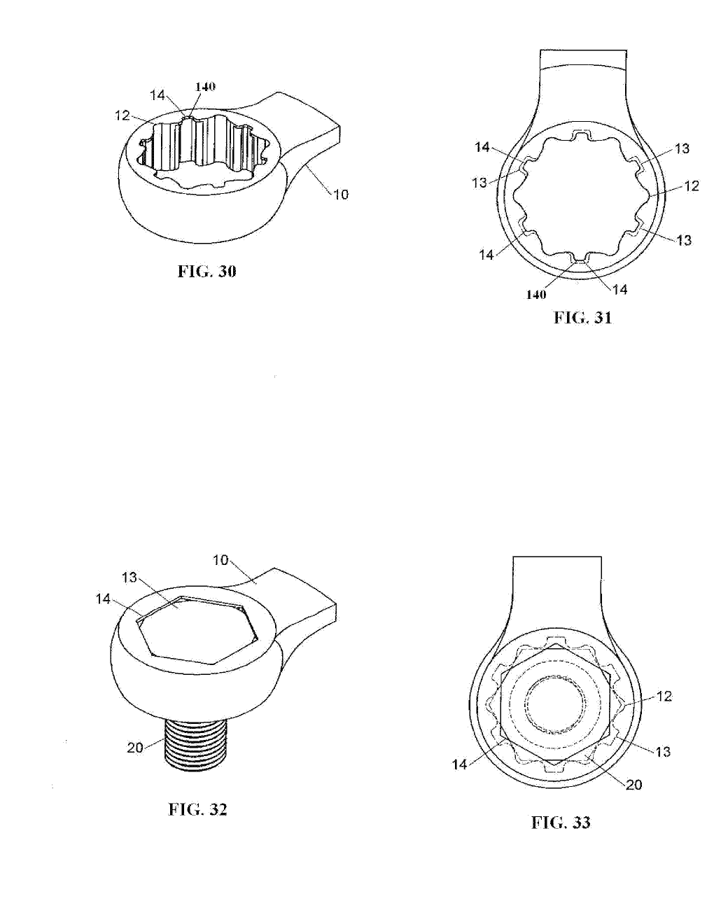

In the embodiment shown in FIGS. 30 and 31, the stop parts 14 have indentations 140 that have similar shapes with the concavities 13 and are deflected toward the central longitudinal axis of the driving head 10.

In the embodiment shown in FIGS. 32 and 33, the number of the stop part 14 is twelve, which are located on the grooves 12 and the concavities 13 one by one and are all located on the first end of the driving head 10. These stop parts 14 connect with each other to form a hexagonal inner circumference for accommodating another workpiece 20. If the forefront surfaces 11 of the driving head 10 can rotate a 19 mm workpiece, the inner circumference of the stop parts 14 can rotate an 18 mm workpiece.

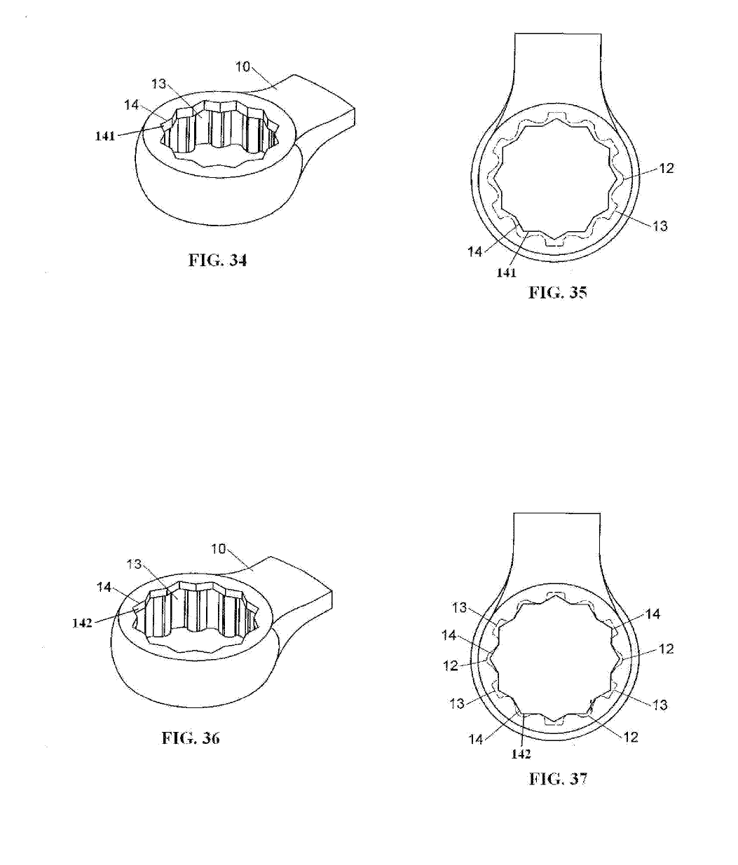

In the embodiment shown in FIGS. 34 and 35, the number of the stop part 14 is twelve, which are located on the grooves 12 and the concavities 13 one by one and are all located on the first end of the driving head 10. The inner circumference formed by the connection of these stop parts 14 includes twelve V-shaped indentations 141 that have the same shapes and are spaced equidistantly for driving a smaller size of workpiece.

In the embodiment shown in FIGS. 36 and 37, the number of the stop part 14 is twelve, which are located on the grooves 12 and the concavities 13 one by one and are all located on the first end of the driving head 10. The inner circumference formed by the connection of these stop parts 14 includes twelve V-shaped indentations 142 that have the same shapes and are spaced equidistantly for driving a workpiece with same size.

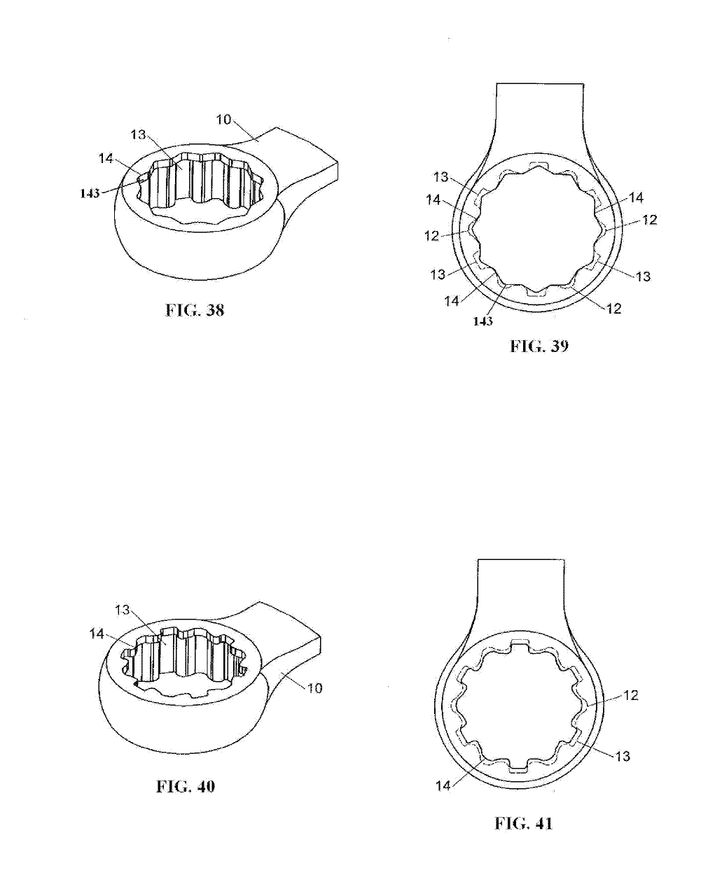

In the embodiment shown in FIGS. 38 and 39, the number of the stop part 14 is twelve, which are located on the grooves 12 and the concavities 13 one by one and are all located on the first end of the driving head 10. The inner circumference formed by the connection of these stop parts 14 includes twelve round arc indentations 143 that have the same shapes and are spaced equidistantly.

In the embodiment shown in FIGS. 40 and 41, the number of the forefront surface 11, the groove 12 and the concavity 13 each are six. The number of the stop part 14 is twelve, which are all located on the first end of the driving head 10. The shape of the inner circumference formed by the connection of these stop parts 14 is the same as the inner shape of the second end of the driving head 10.

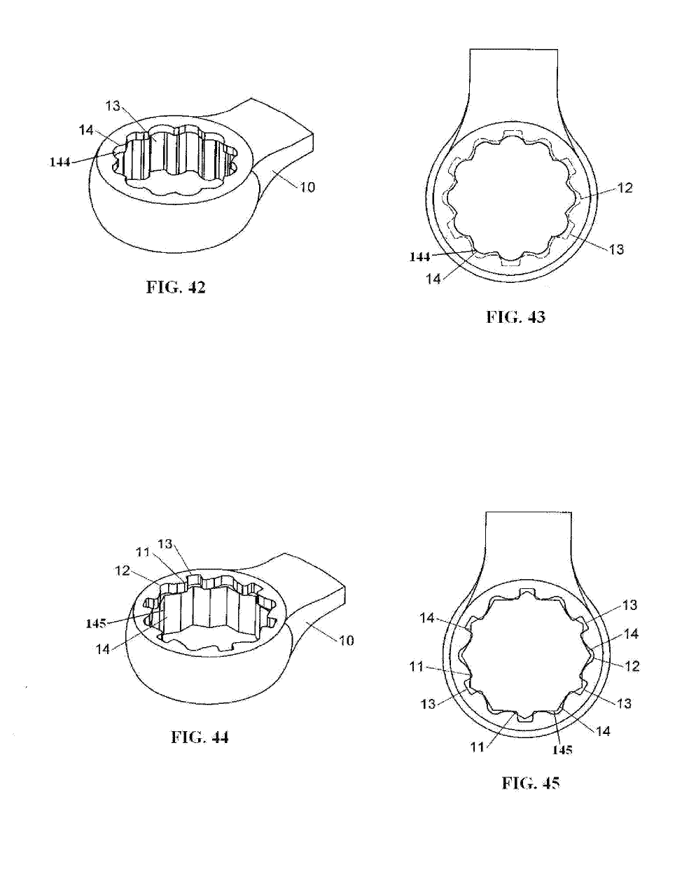

In the embodiment shown in FIGS. 42 and 43, the number of the stop part 14 is twelve, which are all located on the first end of the driving head 10. The number of the forefront surface 11, the groove 12 and the concavity 13 each are six. The inner circumference formed by the connection of these stop parts 14 includes six equidistant first indentations 144. The shape of each said first indentations 144 is similar to the shape of the groove 12, which has the function of rotating dual size of workpieces.

In the embodiment shown in FIGS. 44 and 45, the number of the stop part 14 is twelve, which are located on the grooves 12 and the concavities 13 one by one and are all located on the first end of the driving head 10. The inner circumference formed by the connection of these stop parts 14 includes twelve equidistant V-shaped second indentations 145.

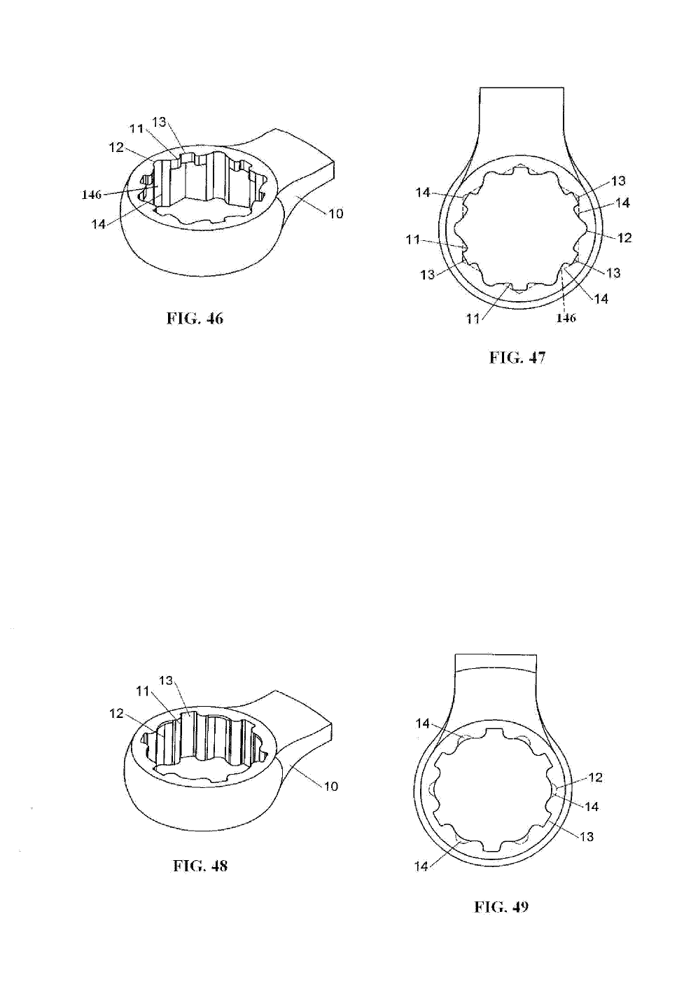

In the embodiment shown in FIGS. 46 and 47, the number of the stop part 14 is twelve, which are located on the grooves 12 and the concavities 13 one by one and are all located on the first end of the driving head 10. The inner circumference formed by the connection of these stop parts 14 includes twelve equidistant V-shaped third indentations 146. The partial portions of the forefront surfaces 11 are more prominent than the third indentations 146.

In the embodiment shown in FIGS. 48 and 49, the stop parts 14 are located on the grooves 12, namely the grooves 12 are not through. The ends of the stop parts 14 are in the form of curved surfaces and the junctions of the curved surfaces of the stop parts 14 and the curved surfaces of the forefront surfaces 11 are round corners.

In the embodiment shown in FIGS. 50 and 51, the stop parts 14 are located on the grooves 12. In the embodiment shown in FIGS. 50 and 51, the ends of the stop parts 14 may have fourth indentations 147 that have the same shapes as the concavities 13.

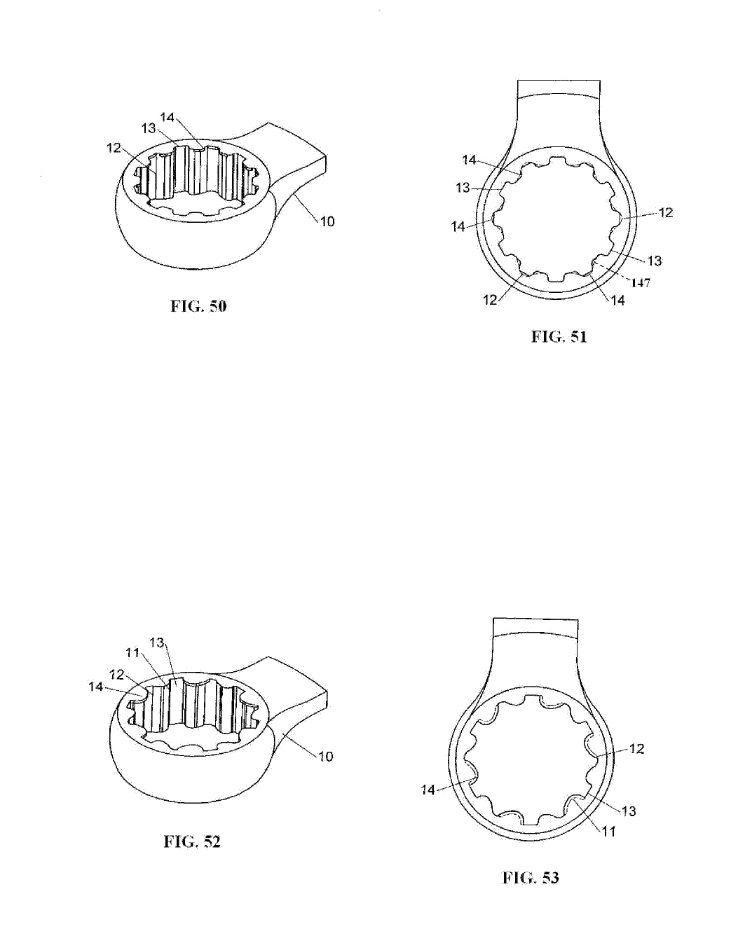

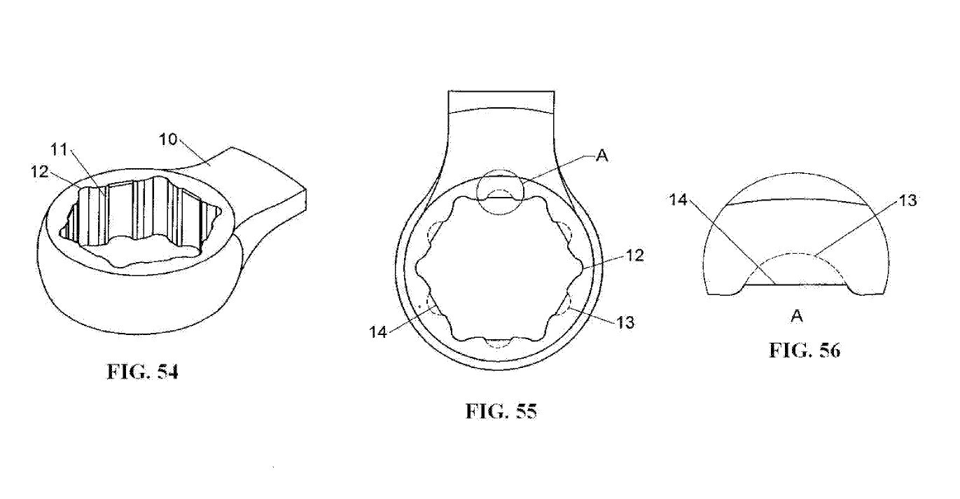

In the embodiment shown in FIGS. 52 and 53, the stop parts 14 are located on the forefront surfaces 11.

In the embodiment shown in FIGS. 54 to 56, the concavities 13 are round arc surfaces and the stop parts 14 are located on the concavities 13.

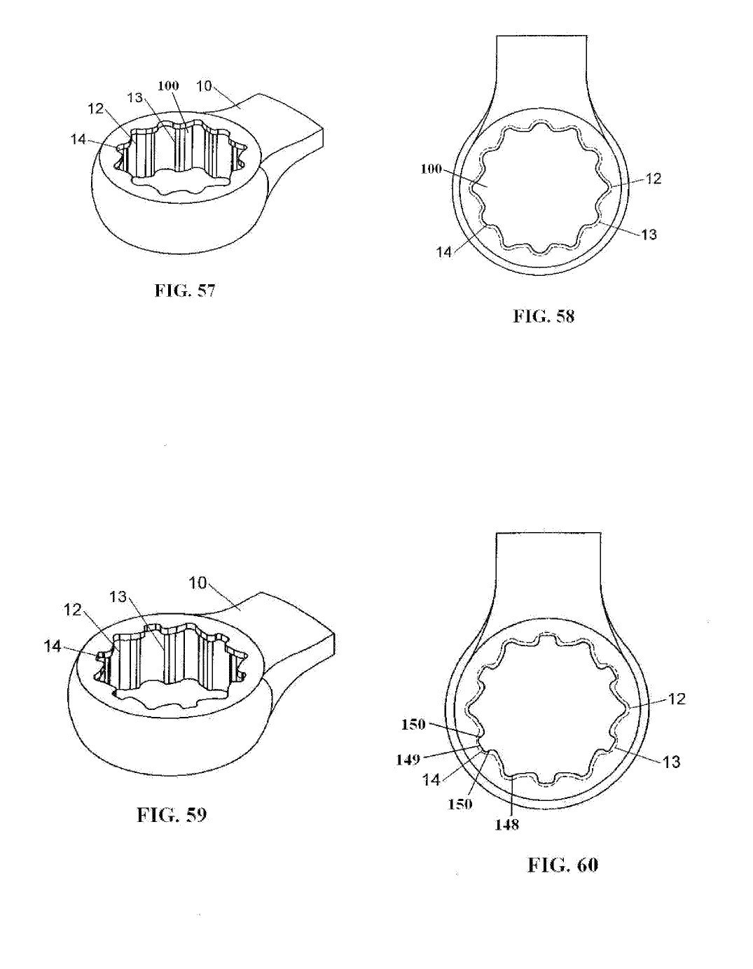

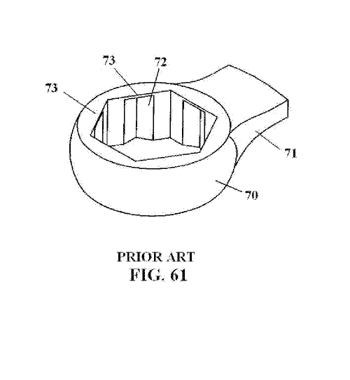

In the embodiment shown in FIGS. 57 and 58, the number of the forefront surface 11, the groove 12 and the concavity 13 each are six. Each said concavity 13 is a round arc surface. The number of the stop part 14 is twelve, which are all located on the first end of the driving head 10. The shape of the inner circumference formed by the connection of these stop parts 14 is similar to the inner shape of the opening 100 on the second end of the driving head 10.

In the embodiment shown in FIGS. 59 and 60, the number of the forefront surface 11, the groove 12 and the concavity 13 each are six, each said concavity 13 is a round arc surface. The number of the stop part 14 is twelve, which are all located on the first end of the driving head 10. The inner circumference formed by the connection of the stop parts 14 includes six equidistant fifth indentations 148 and six equidistant sixth indentations 149. The shape of each said fifth indentation 148 is similar to the shape of the groove 12, and each said sixth indentations 149 includes two parallel sides 150.

Another embodiment of the present invention, the forefront surface of the driving head includes at least two protruded curved surfaces, which is not shown with a figure. The present invention may also have the driving head be equipped with a gap on one side, which is also not shown with a figure.

While we have shown and described the embodiment in accordance with the present invention, it should be clear to those skilled in the art that further embodiments may be made without departing from the scope of the present invention.

What is claimed is:

1. A structure of a wrench, which comprises a driving head and a handle extending from one side of the driving head integrally, the driving head having a first end and a second end in opposite directions, and a central longitudinal axis extending to connect the first end and the second end, at least one said end of the driving head having an opening extending along the central longitudinal axis, the opening having a plurality of grooves that are distributed equidistantly around an internal periphery thereof, the extending directions of the grooves being parallel to the central longitudinal axis, a portion connecting each two adjacent said grooves forming a forefront surface, wherein each said forefront surface is equipped with a concavity on the middle thereof and the extending direction of the concavity is parallel to the central longitudinal axis, the shapes of the concavities and the grooves being different, the concavities and the grooves being able to accommodate teeth of a gear-shaped workpiece together, wherein one said end of the driving head is equipped with at least a stop part projecting toward the central longitudinal axis on an inner of the opening, so that when the workpiece inserted into the opening from the other said end of the driving head, which can be blocked by the stop part.

2. The wrench as claimed in claim 1, wherein the number of the forefront surface and the groove of the driving head each are six, which being disposed annularly in an interlaced order.

3. The wrench as claimed in claim 1, wherein the grooves and the forefront surfaces each are in the form of curved surfaces and a junction of the two curved surfaces is tangent to each other.

4. The wrench as claimed in claim 1, wherein the number of the concavity and the number of the forefront surface are the same.

5. The wrench as claimed in claim 1, wherein the number of the concavity is six and each of the concavities can accommodate a tooth of a workpiece with six equidistant encircling teeth.

6. The wrench as claimed in claim 1, wherein the concavity includes two side surfaces and a bottom.

7. The wrench as claimed in claim 6, wherein the two side surfaces of the concavity are parallel.

8. The wrench as claimed in claim 6, wherein an included angle of the two side surfaces of the concavity may be greater than 90 degree.

9. The wrench as claimed in claim 6, wherein an included angle of the two side surfaces of the concavity may be smaller than 90 degree.

10. The wrench as claimed in claim 6, wherein the bottom of the concavity may be an arc surface.

11. The wrench as claimed in claim 6, wherein the bottom of the concavity may be a flat surface.

12. The wrench as claimed in claim 1, wherein the number of the stop part is six.

13. The wrench as claimed in claim 1, wherein the stop part is located on the concavity near the first end of the driving head.

14. The wrench as claimed in claim 1, wherein a curved surface on a distal end of the stop part is on the same curved surface as the forefront surface.

15. The wrench as claimed in claim 1, wherein the number of the stop part is three that are located on three equidistant said concavities respectively.

16. The wrench as claimed in claim 1, wherein the number of the stop part is one that is located on one of said concavity.

17. The wrench as claimed in claim 1, wherein the number of the stop part is six, three of the stop parts being located equidistantly on the concavities near the first end of the driving head and the other three being located equidistantly on the concavities near the second end of the driving head.

18. The wrench as claimed in claim 1, wherein the number of the stop part is six, three of the stop parts being located equidistantly on the opening near the first end of the driving head and the other three being located equidistantly on the opening near the second end of the driving head.

19. The wrench as claimed in claim 1, wherein a distal end of the stop part is formed as a concave curved surface and the forefront surface is a convex curved surface, the junction of the curved surface of the stop part and the curved surface of the forefront surface being a round corner.

20. The wrench as claimed in claim 1, wherein a distal end of the stop part is formed as a concave curved surface and a shape of the concave curved surface of the stop part is the same shape as the groove.

21. The wrench as claimed in claim 1, wherein the number of the stop part is twelve which being located on the grooves and the concavities one by one and are all located on the first end of the driving head, the stop parts connecting with each other to form a hexagonal inner circumference for accommodating another workpiece.

22. The wrench as claimed in claim 1, wherein the number of the stop part is twelve which are located on the grooves and the concavities one by one and are all located on the first end of the driving head, an inner circumference formed by a connection of the stop parts including twelve round arc indentations that have the same shapes and are spaced equidistantly.

23. The wrench as claimed in claim 1, wherein the number of the forefront surface, the groove and the concavity each are six, the number of the stop part being twelve which are all located on the first end of the driving head, a shape of an inner circumference formed by a connection of the stop parts being the same as an inner shape of the opening of the second end of the driving head.

24. The wrench as claimed in claim 1, wherein the number of the stop part is twelve which are all located on the first end of the driving head and the number of the forefront surface, the groove and the concavity each are six, an inner circumference formed by a connection of the stop parts including six equidistant first indentations, a shape of each said first indentation being similar to a shape of the groove.

25. The wrench as claimed in claim 1, wherein the number of the stop part is twelve which are located on the grooves and the concavities one by one and are all located on the first end of the driving head, an inner circumference formed by a connection of the stop parts including twelve equidistant V-shaped second indentations.

26. The wrench as claimed in claim 1, wherein the number of the stop part is twelve which are located on the grooves and the concavities one by one and are all located on the first end of the driving head, an inner circumference formed by a connection of the stop parts including twelve equidistant V-shaped third indentations, partial portions of the forefront surfaces being more prominent than the third indentations.

27. The wrench as claimed in claim 1, wherein the stop part is located on the groove.

28. The wrench as claimed in claim 1, wherein the stop parts are located on the grooves and distal ends of the stop parts have forth indentations that have same shapes as the concavities.

29. The wrench as claimed in claim 1, wherein the stop part is located on the forefront surface.

30. The wrench as claimed in claim 1, wherein the concavity is a round arc surface.

31. The wrench as claimed in claim 1, wherein the number of the forefront surface, the groove and the concavity each are six, each said concavity being a round arc surface, the number of the stop part being twelve which are all located on the first end of the driving head, a shape of an inner circumference formed by a connection of the stop parts being similar to an inner shape of the opening on the second end of the driving head.

32. The wrench as claimed in claim 1, wherein the number of the forefront surface, the groove and the concavity each are six, each said concavity being a round arc surface, the number of the stop part being twelve which are all located on the first end of the driving head, an inner circumference formed by a connection of the stop parts including six equidistant fifth indentations and six equidistant sixth indentations, a shape of each said fifth indentation being similar to a shape of the groove and each said sixth indentation including two parallel sides.

33. The wrench as claimed in claim 1, wherein the forefront surfaces is a curved surface projecting toward the central longitudinal axis.

34. The wrench as claimed in claim 1, wherein an end of the stop part is formed as a concave curved surface that is a paraboloid and a junction of the paraboloid and the concavity is a round corner.

35. The wrench as claimed in claim 1, wherein the forefront surface consists of at least two protruded curved surfaces.

36. The wrench as claimed in claim 1, wherein the driving head has a gap on one side.
